(19) United States
(12) Patent Application Publication
(10) Pub. No.: US 2009/0245546 A1
(43) Pub. Date: Oct. 1, 2009

(54) Medium/Low Band Sound Reinforcement Film-Type Audio-Speaker Using Piezoelectric Film as Vibration Element

(75) Inventors: Ju Seon Youn, Incheon-si (KR); Chang Ju Ra, Gyeonggi-do (KR)

Correspondence Address: THE WEBB LAW FIRM, P.C., 700 KOPPERS BUILDING, 436 SEVENTH AVENUE, PITTSBURGH, PA, 15219, US

(73) Assignee: DREAM SONIC TECHNOLOGY LIMITED, Hong Kong (CN)

(21) Appl. No.: 12/092,035

(22) PCT Filed: Feb. 10, 2006
(86) PCT No.: PCT/KR2006/000488

§ 371 Date: Dec. 3, 2008

(30) Foreign Application Priority Data
Oct. 29, 2005 (KR) 10-2005-0102670

(51) Int. Cl. H04R 17/00

(52) U.S. Cl. 381/190

(57) ABSTRACT

A film-type audio-speaker is provided that uses a piezoelectric film as a vibration element to provide a reinforcement of the low to medium frequency band sound waves generated. The film-type audio-speaker uses a piezoelectric film as a vibration element and comprises a piezoelectric film with an electrically conductive polymer or metal layer coated on its surface, a terminal portion electrically connected to the piezoelectric film; and an audio-speaker driving unit connected to the terminal portion. The film-type audio-speaker has a cover member that is made of a porous material attached to the front surface and/or the rear surface of the piezoelectric film.

### TECHNICAL FIELD

The present invention relates to a film-type audio-speaker using a piezoelectric film as a vibration element that provides a reinforcement of the low to medium frequency band sound waves generated, and more particularly, to film-type audio-speaker using a piezoelectric film as a vibration element that provides a reinforcement of the low to medium frequency band sound waves generated, in which the high frequency band sound wave which is generated from a conventional film-type audio-speaker and which is offensive to the human ear is attenuated and in which the low to medium frequency band sound waves are reinforced, thereby resulting in a high-quality sound generated.

### BACKGROUND ART

A conventional audio-speaker for an acoustic device is formed of a cone-shaped audio-speaker unit including a cone having a vibration plate and an enclosure playing the role of a resonance chamber. Accordingly, the conventional audio-speaker is large and heavy. Recently, a film-type audio-speaker constructed of a thin and light film has been developed and introduced. The film-type audio-speaker is produced with a piezoelectric film in which plasma is applied to a PVDF (poly vinylidene fluoride) film or other resin films resulting in a conversion of the film into one with a hydrophilic property, and in which metal or other electrically conductive materials are coated onto the surface of the PVDF film or other resin films. Accordingly, when an audio signal is applied to the piezoelectric film, sound waves are generated by the piezoelectric film corresponding to the audio signal applied.

### DISCLOSURE OF INVENTION

### Technical Problem

By the way, in the film-type audio-speaker formed of a piezoelectric film for use as a conventional audio-speaker, the vibrating film is directly exposed to the surrounding air in order to generate sound waves, resulting in the high frequency band sound wave that is offensive to the human ear being transmitted to the human ear without being filtered. Thus, although the existing film-type audio-speaker is thin and light and can also be used in a variety of applications, the quality of the sound waves generated is comparatively lower than that generated by a cabinet-type audio-speaker in which a vibration plate is surrounded by an enclosure that allows various manipulations for the characteristics of the sound waves such as reinforcement or attenuation of a specific frequency of the sound waves to be achieved.

### Technical Solution

To provide a solution to the above problems of the conventional film-type audio-speaker, it is an object of the present invention to provide a film-type audio-speaker of a new structure which can attenuate the high frequency band sound wave that is offensive to the human ear and can provide a reinforcement of the low to medium frequency band sound waves resulting in a high quality sound being generated.

To accomplish the above object of the present invention, there is provided a film-type audio-speaker using a piezoelectric film as a vibration element that provides a reinforcement of the low to medium frequency band sound waves, which comprises a piezoelectric film with an electrically conductive polymer or metal layer coated onto its surface and a terminal portion electrically connected to the piezoelectric film and to which an audio-speaker driving unit is connected, the film-type audio-speaker is characterized in that a cover member made of a porous material is attached to the front surface and/or the rear surface of the piezoelectric film.

According to another feature of the present invention, the cover member comprises a porous soft sheet having a plurality of pores, or a hard perforated plate having a plurality of fine perforations or comprises two overlapping layers with one layer being the porous soft sheet and the other being the hard perforated plate.

According to still another feature of the present invention, the porous soft sheet is placed at the inner side of the piezoelectric film so as to face the piezoelectric film, and the hard perforated plate is placed at the outer side of the porous soft sheet.

According to yet another feature of the present invention, a space-adjustment edge member is placed between the piezoelectric film and the hard perforated plate.

### Advantageous Effects

As described above, the present invention provides a sound reinforcement film-type audio-speaker using a conventional piezoelectric film as a vibration element that provides a reinforcement of the low to medium frequency band sound waves generated. In the present invention, cover members made of porous soft sheets or hard perforated plates, or a unit obtained by placing the porous soft sheets and the hard perforated plates over one another are attached to the outer surface of the piezoelectric film, thereby preventing the piezoelectric film from being exposed to the surrounding air. Accordingly, absorption or attenuation of the high frequency sound waves is accomplished by the porous soft sheets, or a resonant effect or flanging effect is accomplished by the hard perforated plates. As a result, the low to medium frequency band sound waves are reinforced or the frequency band-width of the sound wave generated is widely extended. Also, due to the interception or attenuation effect on the high frequency band sound waves, high frequency band sound wave that is offensive to the human ear is weakened and the low to medium frequency band sound waves are either maintained or reinforced, resulting in a film-type audio-speaker that can generate sound waves of a smooth and excellent quality.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a partially exposed detailed perspective view of a film-type audio-speaker using a piezoelectric film as a vibration element that provides a reinforcement of the low to medium frequency band sound waves generated according to an embodiment of the present invention;

FIG. 2 is an exposed perspective view showing a film-type audio-speaker using a piezoelectric film as a vibration element that provides a reinforcement of the low to medium frequency band sound waves generated of FIG. 1;

FIG. 3 is a perspective view showing a film-type audio-speaker using a piezoelectric film as a vibration element that provides a reinforcement of the low to medium frequency band sound waves generated, according to another embodiment of the present invention;

FIG. 4 is a perspective view showing a film-type audio-speaker using a piezoelectric film as a vibration element that provides a reinforcement of the low to medium frequency band sound waves generated, according to still another embodiment of the present invention; and

FIG. 5 is an exposed perspective view showing a film-type audio-speaker using a piezoelectric film as a vibration element that provides a reinforcement of the low to medium frequency band sound waves generated, according to yet another embodiment of the present invention.

### MODE FOR THE INVENTION

Hereinbelow, a film-type audio-speaker using a piezoelectric film as a vibration element that provides a reinforcement of the low to medium frequency band sound waves generated according to respective preferred embodiments of the present invention will be described in detail with reference to the accompanying drawings.

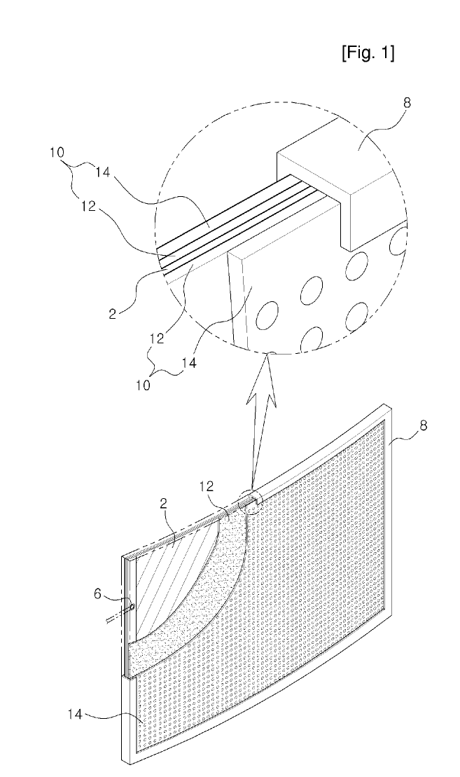

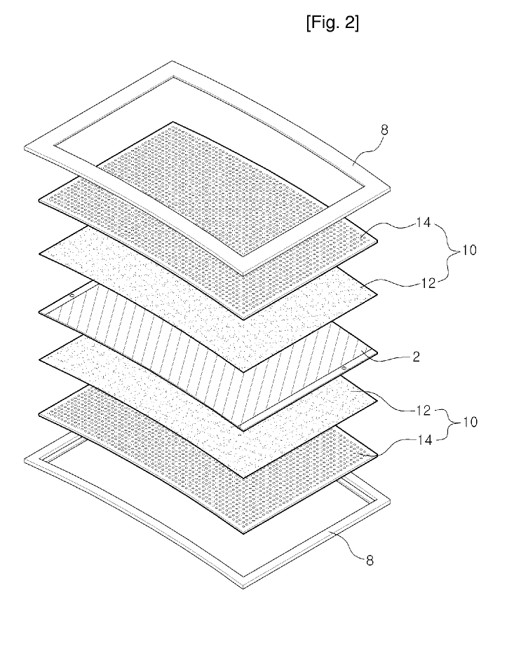

FIG. 1 shows a film-type audio-speaker using a piezoelectric film as a vibration element that provides a reinforcement of the low to medium frequency band sound waves generated according to an embodiment of the present invention, and FIG. 2 is an exposed perspective view of FIG. 1. Referring to FIGS. 1 and 2, a film-type audio-speaker 1 using a piezoelectric film as a vibration element that provides a reinforcement of the low to medium frequency band sound waves generated according to an embodiment of the present invention includes a piezoelectric film 2 which is constructed by applying plasma on a PVDF (Poly Vinylidene Fluoride) film or other resin films resulting in a conversion of the surface of the film into one having a hydrophilic property and by coating metal or other electrically conductive materials onto the surface of the piezoelectric film 2, and by electrically connecting a terminal portion 6 to the piezoelectric film 2 and into which an audio signal is applied. Cover members 10 that is formed by overlapping a plurality of layers over one another are symmetrically attached to the front and/or the rear surfaces of the piezoelectric film 2.

In the preferred embodiment of the present invention, an inner cover member among the cover members 10 is made of a porous soft sheet 12 and is placed facing the piezoelectric film 2, and a hard perforated plate 14 which is placed at the outer side of the porous soft sheet 12. These cover members 10 are supported by frames 8, in a manner that these various layers are placed over one another to form an integrated and single unit.

The porous soft sheet 12 may be constructed of various kinds of non-woven fabrics and textiles, thin glass fibers or other mineral materials, foaming agents such as sponge, or soft material sheets having appropriate physical properties and pores. The porous soft sheet 12 is placed very close to the piezoelectric film 2 leaving a very thin space in between or is in very light contact with the piezoelectric film 2, so as not to prevent vibration of the piezoelectric film 2. Also, the thickness of, the number of the pores on or the porosity of the porous soft sheet 12 can be selected appropriately.

Low to medium frequency band sound waves whose wavelengths are relatively longer are transmitted through the porous soft sheet 12, but high frequency band sound wave of short wavelengths is properly attenuated and absorbed in the porous soft sheet 12. Accordingly, a smoother sound with its low to medium frequency band sound waves reinforced can be generated.

Also, the hard perforated plate 14 which is placed at the outer side of the porous soft sheet 12 is preferably made out of an aluminum thin plate being not more than 1 mm in thickness in which a number of minute throughholes are perforated, but can also be made of hard materials such as other metallic or plastic materials. Since the hard perforated plate 14 is placed at the outer side of the porous soft sheet 12, the porous soft sheet 12 functions as a gap-filling material which separates the hard perforated plate 14 from the piezoelectric film 2.

The hard perforated plate 14 provides an effect of reinforcing the low to medium frequency band sound waves generated since sound waves radiated directly from the piezoelectric film 2 and sound waves reflected from the hard perforated plate 14 interfere with each other, thus causing the former to interfere with the latter with a time difference and then resulting in a resonance. In addition, the interference of different sound waves with a time difference brings about a flanging effect that causes an extension of the original frequency band-width into a wider frequency band-width than the original frequency band-width, resulting in an excellent quality of sound generated. Further, when the high frequency band sound wave collides with the non-perforated portion of the hard perforated plate 14, it is intercepted by the hard perforated plate 14 and reflected from its surface resulting in the hard perforated plate 14 being set into vibration. As a result, the high frequency band sound wave is converted into thermal energy and then weakened. As described above, since the cover members 10 made of the porous soft sheet 12 and the hard perforated plate 14 are attached to the outer surfaces of the piezoelectric film 2, the low to medium frequency band sound waves radiated from the piezoelectric film 2 are either maintained or reinforced, but the high frequency band sound wave is partially intercepted or absorbed. Accordingly, the present invention can generate a high quality and smooth sound in which the low to medium frequency band sound waves are reinforced.

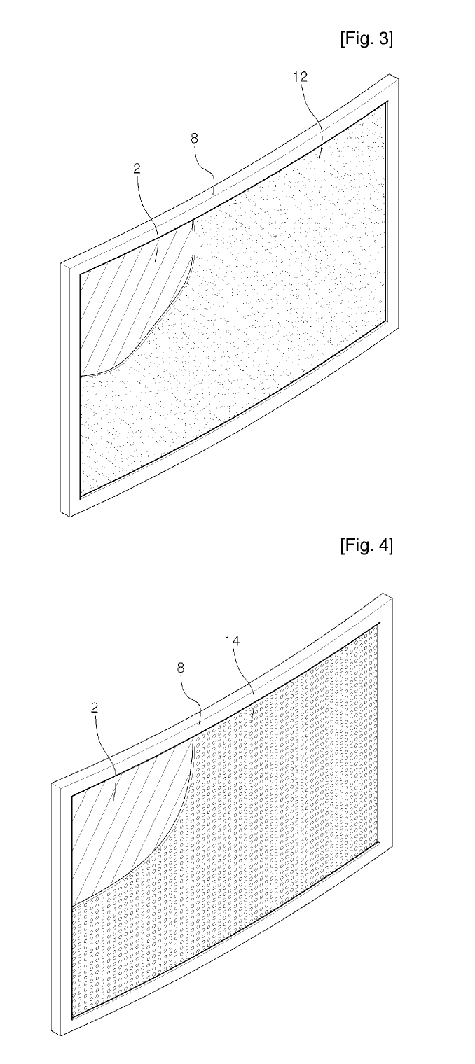

FIG. 3 is a perspective view showing a film-type audio-speaker using a piezoelectric film as a vibration element that provides a reinforcement of the low to medium frequency band sound waves, according to another embodiment of the present invention. Referring to FIG. 3, a porous soft sheet 12 is placed on the front and the rear surfaces of a piezoelectric film 2 in a film-type audio- speaker, respectively, but hard perforated plates 14 of FIGS. 1 and 2 are omitted. Although the hard perforated plates 14 are omitted, the porous soft sheet 12 such as a non-woven fabric transmits the low to medium frequency band sound waves without any attenuation, whereas the high frequency band sound waves are properly attenuated and absorbed. As a result, the film-type audio-speaker according to this embodiment of the present invention can generate an excellent quality of sound in which the low to medium frequency band sound waves are reinforced when compared to the high frequency band sound waves.

FIG. 4 is a perspective view showing a film-type audio-speaker using a piezoelectric film as a vibration element that provides a reinforcement of the low to medium frequency band sound waves generated, according to still another embodiment of the present invention. Referring to FIG. 4, a hard perforated plate 14 in a film-type audio-speaker is placed very close to or in very light contact with either the front or the rear surfaces of a piezoelectric film 2 leaving a very thin space in between, so as not to prevent vibration of the piezoelectric film 2. As described above, the low to medium frequency band sound waves are reinforced due to the resonance phenomenon of the sound waves radiating directly from the vibration element and the sound waves reflected from the hard perforated plate 14, and high frequency band sound wave is then intercepted to a certain degree. As a result, a high quality film-type audio-speaker according to this embodiment of the present invention can be also obtained, in which the low to medium frequency band sound waves are reinforced.

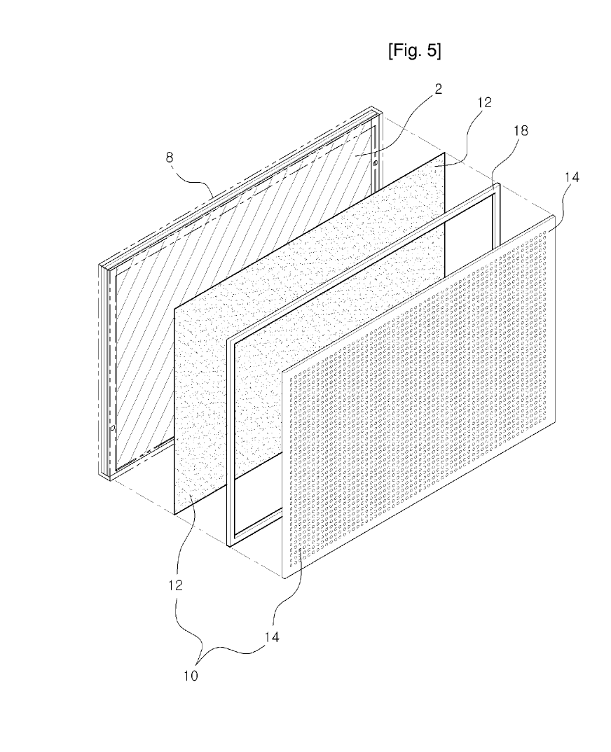

FIG. 5 is an exposed perspective view showing a film-type audio-speaker using a piezoelectric film as a vibration element that reinforces the low to medium frequency band sound waves, according to yet another embodiment of the present invention. Referring to FIG. 5, an edge member 18 of a certain thickness is interposed between a piezoelectric film 2 and a hard perforated plate 14, in more specifically, between a porous soft sheet 12 and a hard perforated plate 14. Accordingly, the space between the piezoelectric film 2 and the hard perforated plate 14 can be adjusted within a range from a few millimeters to a few tens of millimeters. As a result, a reflection and interference phenomenon of sound in the hard perforated plates 14 can be adjusted to generate a quality of the sound desired by the user. The edge member 18 may be placed between the piezoelectric film 2 and the porous soft sheet 12. However, in the case that there are no porous soft sheets 12 as in the FIG. 4 embodiment, the edge member 18 may be placed between the piezoelectric film 2 and the hard perforated plate 14.

As described above, the present invention has been described with respect to particularly preferred embodiments. However, the present invention is not limited to the above embodiments, and it is possible for one who has an ordinary skill in the art to make various modifications and variations, without departing off the principles of the present invention.

1. A film-type audio-speaker using a piezoelectric film as a vibration element that provides a reinforcement of the low to medium frequency band sound waves generated, the film-type audio-speaker comprising:
a piezoelectric film with an electrically conductive polymer or a metal layer coated onto a surface thereof;
a terminal portion electrically connected to the piezoelectric film; and
an audio-speaker driving unit connected to the terminal,
wherein, a cover member made of a porous material is attached to a front surface and/or a rear surface of the piezoelectric film.

2. The film-type audio-speaker according to claim 1, wherein the cover member comprises a porous soft sheet on which a plurality of pores are formed, a hard perforated plate on which minute throughholes are perforated, overlapping layers of the porous soft sheet and the hard perforation plate or any combination thereof.

3. The film-type audio-speaker according to claim 2, wherein the porous soft sheet is placed at an inner side of the piezoelectric film so as to face the piezoelectric film, and the hard perforated plate is placed at an outer side of the porous soft sheet.

4. The film-type audio-speaker according to claim 2, wherein a space adjustment edge member is placed between the piezoelectric film and the hard perforated plate.

5. The film-type audio-speaker according to claim 3, wherein a space adjustment edge member is placed between the piezoelectric film and the hard perforated plate.
